(19) United States
(12) Patent Application Publication
(10) Pub. No.: US 2011/0049908 A1
(43) Pub. Date: Mar. 3, 2011

(54) Systems and Methods for Providing Multi-Purpose Renewable Energy Storage and Release

(76) Inventor: Randall M. Chung, Laguna Niguel, CA (US)

(21) Appl. No.: 12/550,992

(22) Filed: Aug. 31, 2009

(51) Int. Cl. H02K 7/18

(52) U.S. Cl. 290/1 R

(57) ABSTRACT

A refrigeration unit or system is used to at least partially freeze water. The at least partially frozen water may then be separated into ice and water. The ice may be stored and allowed to melt, thereby providing an ice portion and a melted ice water portion. When energy release is desired, the melted ice water portion along with a hot liquid may be used to drive a thermal motor. The thermal motor may then in turn drive the electric generator, resulting in electric energy production.

### FIELD OF THE INVENTION

The present invention relates generally to energy storage and release systems, and more particularly to an electric power plant or system configured to desalinate water and store energy in cold water and ice.

### BACKGROUND OF THE INVENTION

Renewable energy systems such as solar, wind, or tidal generation are dependent on external factors largely out of our control. Solar energy can only be produced during the day and is subject to cloud cover. Wind energy in turn depends on the wind speed being in an optimal range which is neither too weak nor too strong. Consequently, as renewable energy systems become more pervasive, control over the amount of total energy available at a given time decreases.

Utility companies may compensate for this lack of control in two ways. First, excess controllable power generation may be built such as natural gas, coal, or nuclear power. This option has numerous disadvantages including the cost for fuel, significant capital expenditures, and negative effects on the environment. Additionally, many governments disincentivize investment in these power sources.

Second, utilities may invest in energy storage to capture excess output generated by renewable energy systems. Because it is hard to control when renewable energy systems produce energy, these systems often produce excess energy that, unless stored, is wasted. If a system instead captures and stores this energy, the same system can control and release this energy during periods where power demand exceeds power supply.

Renewable energy systems based on solar, wind, tidal or wave energy sources address many environmental problems, but also have a severe disadvantage because they cannot generate power continuously and dependably. For instance, the power from solar based systems can only be produced during the day and can be affected by sun angle, clouds, and dust in the air or on solar panels and mirrors. Power output may be lower on cloudy days and no power can be generated at night. Power from wind based systems depends on wind speed. Periods of low wind may result in little to no power output, and low wind conditions often last for days. High winds may also force the equipment to be shut down to protect the rotating machinery from damage. Tidal and wave based power may also experience long periods of low energy production.

Currently, to solve the above problems, utilities combine the power output from renewable energy systems along with power generated from conventional electric power plants. Conventional power plants often have surplus capacity and can increase their power output to accommodate the varying power output of any renewable energy systems.

However, as the proportion of renewable energy sources to conventional power plants grows it becomes more difficult and costly for the conventional power plants to compensate for the varying power. Indeed, both the total demand for electricity and the supply of electric power from a renewable energy system can change quickly, sometimes on a minute to minute time frame. This means more surplus generation capacity must be built, which increases costs. Any surplus generation capacity must be reliable and able to respond to quick changes in electricity demand.

Thus, electric utilities must have a certain amount of excess capacity provided by dependable energy generation sources whose output can be quickly adjusted to meet changes in electricity demand, or to compensate for changes in generation capacity from a renewable energy plant. Doing otherwise risks interruptions in electricity service to the utility's customers.

Consequently, there is a need for a way to store energy from renewable energy systems so that excess power can be stored in times of energy surplus and released in times of energy deficiency.

Various systems have been invented or used to store and deliver energy from electric power plants. One such method is using electric power to pump water up to a reservoir higher in altitude. When power is needed, the stored water can be piped back down to turn a turbine generator. Although small reservoirs or water tanks can be situated in many places, reservoirs large enough to store and generate megawatts of power for many hours are expensive to build or cannot be situated at a desirable site.

Another method is to store hot molten salt or hot oil from a solar thermal plant. When power is needed, the hot fluid can be used to generate steam to turn a turbine generator. Tanks large enough to store and generate megawatts of power for many hours are expensive to build. In the case of hot oil, storing large amounts of hot flammable oil can be hazardous. In the case of hot salt, it must not be allowed to cool significantly or it will freeze. In addition, hot salt is corrosive to many ordinary piping and pumping materials creating extensive engineering problems.

Energy storage can also be accomplished using compressed air (U.S. Pat. No. 5,491,969), where electric energy is used to compress air and store the compressed air in a chamber. When electric power is needed, the air compressor is shut down and compressed air from the storage chamber is fed into a combustor, along with flammable gas, to spin a turbine-generator. In this system, the compressed air by itself is not used to spin a turbine, but instead used to increase the combustion efficiency of a conventionally fueled generator. One problem is that large leak free underground caverns or chambers nay not be situated in desirable locations. Another is that pipes may have to be drilled to depths of thousands of feet incurring significant costs.

Energy storage using conventional chemical batteries is common and relatively simple, but because of the cost of batteries, systems which can deliver megawatts of power may only last for a few minutes.

Energy storage can also be accomplished using chemical decomposition of steam (U.S. Pat. No. 5,492,777) as a form of chemical battery. This system operates at high temperatures of 600 to 1200 degrees Centigrade. Its special design and narrow field of use may make it more expensive than conventional batteries.

Various other systems have been invented for storing energy, though not necessarily for power plant use. One such method is energy storage by salt hydration (U.S. Pat. No. 4,303,121). Heat is stored by heating and drying certain salts, and is released when water is added. Storing large amounts of heat energy requires a large amount of particular kinds of salt.

Thus, there is a need in the art for systems and methods that can efficiently store excess energy generated from renewable energy systems and selectively output power.

### BRIEF SUMMARY OF THE INVENTION

Disclosed and claimed herein are systems and methods for storing renewable energy and releasing the stored energy. In one embodiment, a system includes a refrigeration unit configured to at least partially freeze water into ice and further configured to separate the ice from an unfrozen water portion. The system further includes an insulated cold storage unit configured to receive and store said ice and any melted ice water portion of said ice, and a thermal motor configured to operate when electricity is demanded. In certain embodiments, the thermal motor is configured to be driven by each of said melted ice water portion and a hot liquid provided by a hot liquid source. Additionally, the system includes an electrical generator driven by the thermal motor wherein the electrical generator is configured to produce electricity.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A depicts a simplified block diagram of an energy storage and release system according to one or more embodiments of the invention;

FIG. 1B depicts a simplified block diagram of an energy storage and release system according to one or more embodiments; and

FIG. 2 depicts a method for operating an energy storage and release system according to one or more embodiments.

### DETAILED DESCRIPTION OF THE EXEMPLARY EMBODIMENTS

### Overview and Terminology

One aspect of the invention relates to an energy storage and release system. In one embodiment, the energy storage system may be configured to economically store and release many megawatts or gigawatts of power for hours and days at a time. The energy storage system may also be manufactured of environmentally benign components.

In another embodiment, the energy system may be configured to utilize energy storage of ice. By way of example, water and/or other fluids can be frozen at night when electric power is less expensive. The ice can then be melted and used for refrigeration and air conditioning during the day.

According to another embodiment, the energy storage and release system may be configured to utilize energy storage of ice and desalination of water. For example, the energy system can store energy as ice until needed, then convert the stored energy back into electricity and at the same time desalinate water through freezing and thawing of saline water.

Storing energy as ice and converting ice-energy back into electricity has a number of advantages. First, a large amount of energy can be stored and released. It requires 80 calories of energy to freeze one gram of water into ice. Therefore, it requires 200 billion calories to melt 2.5 million kilograms of ice. This is equal to about 230 megawatt-hours of energy. Second, large amounts of ice can be practically stored. A two meter deep Olympic size swimming pool of 25 meters by 50 meters contains 2.5 million liters of water. Because large wind farms and solar energy farms can be hundreds or thousands of acres in size, the amount of land required to store millions of liters of water and ice is relatively small by comparison. Furthermore, no exotic chemicals or materials are used, so the system is environmentally friendly. Finally, the system can be a reliable source of electricity and cool water, useful for powering and cooling nearby businesses such as computing data centers or office buildings.

As will be described in more detail below, input electric power and water may be received by a renewable energy storage and release system during an energy storage mode. A refrigeration unit, which may be powered by electricity, may then freeze or cool the inputted water, which is then stored in an insulated storage unit indefinitely until power generation is required.

Once power generation is needed, the system may be caused to enter an energy release mode. In this mode, the cold water from the ice, along with a hot fluid, are together used to energize a thermal motor. The thermal motor drives a shaft which is mechanically connected to an electric power generator. In certain embodiments, a pump can be used to regulate the amount of hot and cold fluid to be used in the thermal motor. Additionally, in certain embodiments, one or more shafts, refrigeration units, pumps, or thermal motors may be used to provide better control over electric output. In short, the system may be configured to operate in two modes, where the first mode is characterized by water and electricity being inputted to the system to generate ice, and the second mode is characterized by using stored heat and the generated ice being used to generate electricity.

The system to provide energy storage and release may include an electrical refrigeration unit to freeze and cool water, a filtering unit to separate ice from unfrozen water, a storage unit to store ice and cold water, a thermal motor driven by melted ice and hot fluid, and a power generator driven by the thermal motor. It should, however, be appreciated that the refrigeration unit need not be an electrical unit. That is, the refrigeration unit may be liquid holding unit that allows cold weather to be used by the system to create the stored ice.

In certain embodiments, energy can also be stored in the hot fluid source. The storage unit, similar to the ice unit, may be configured to convert electricity to heat by heating the fluid. Similarly, sunlight may be used to store heat in the fluid, or a geothermal heat source may be used to heat the hot fluid. Finally, in one embodiment, heat generated by the refrigerating unit may be used to heat the hot fluid.

Another potential advantage of ice energy storage is that saline water can be desalinated through the process of freezing and melting water. That is, the aforementioned system may not only store and release large amounts of energy, but also desalinate brackish water or sea water. Salt or sea water instead of fresh water can be taken as an input to the system. Fresh water is then generated through the creation of ice and can be used and sold for agricultural or industrial purposes, thus reducing the overall system operational cost.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

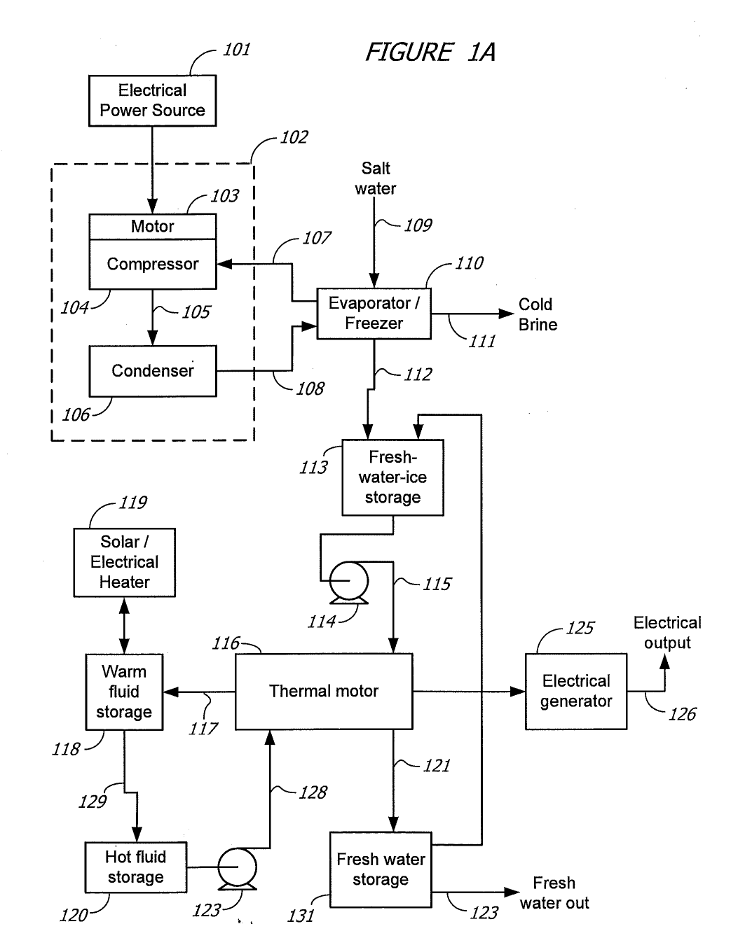

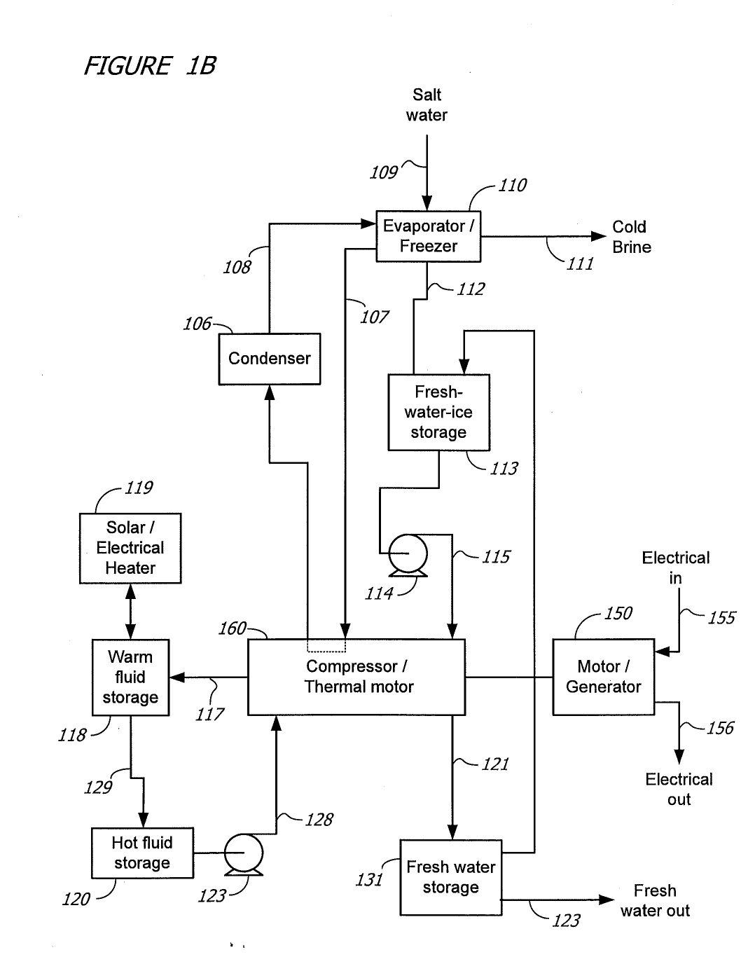

Referring now to the figures, FIGS. 1A-1B depict energy storage and release system according to one or more embodiments of the invention. Referring first to FIG. 1A, a system is depicted which operates in a first configuration mode, the energy storage mode. As shown, an electric power source 101, which may consist of electric power from a renewable power source such as a wind or solar power plant or alternatively power from a conventional source, is used to power a refrigeration unit 102. The refrigeration unit 102 normally includes an electrical motor 103 turning a compressor 104, which compresses low pressure refrigerant gas, shown as 107 into hot high pressure refrigerant gas, shown as 105. The hot high pressure refrigerant gas 105 then goes to a condenser 106 which may consist of a series of coils or tubes, passively cooled by exposure to outside or conditioned air, where the pressurized heated gas is cooled and condenses into refrigerant fluid still under pressure, shown as 108. Although FIG. 1 only shows a single motor 103, compressor 104, and condenser 106, in other embodiments it is possible to have a plurality of separate motors, compressors, and condensers, which may make it easier to handle large swings of input, as typical from many renewable energy technologies.

The cooled high pressure refrigerant fluid 108 is then moved into the evaporator/freezer unit 110. The refrigerant fluid 108 experiences a decrease in pressure in the evaporator unit 110, resulting in evaporation and cooling of the liquid. The liquid 108 then extracts heat from the freezer compartment to freeze salt water, shown as 109, into ice, shown as 112. The system must cool the water 109, but the water 109 need not fully freeze into ice. Although the system of FIG. 1A is described with reference to salt water, it should also be appreciated that the system may operate using fresh water according to another embodiment of the invention. If the water 109 is salty and is only partially frozen, the ice 112 formed will have a lower concentration of salt and the remaining unfrozen brine 111 will have an increased salt concentration. The brine 111 can be discarded, sent to an evaporation pond, or can be used as part of the solar heated fluid loop 117-124 in other embodiments. Even if the ice 112 still contains some residual salt, in other embodiments, the salt level may still be low enough to use as drinking or irrigation water or for other industrial uses once it exits from the system at fresh water output 123. Alternatively, in another embodiment, the lower salinity water 123 from the system can be fed back in as incoming water 109 to undergo additional freeze/thaw cycles for further salinity reduction.

According to another embodiment of the invention, cool and/or desalinated water of the system of FIG. 1A may be used to provide cooling water for an office building, residential building, computer data center, etc. The system may further be configured to provide desalinated water for use as potable drinking water and/or reduced salinity water which may be used for irrigation of crops.

As ice 112 forms, it is transported and stored in one or more ice storage tanks 113. The ice storage tanks 113 may be thermally insulated to minimize the rate at which the ice melts. It is very practical to have one or more ice storage tanks 113 hold millions of kilograms of ice and water compared to the real estate needed for a wind or solar based energy farm.

When the system operates in its second configuration mode, the energy release mode, and it is time to generate power, the ice cold water, shown as 115, and hot fluid 128 are inputted to one or more thermal motors 116. One example of a thermal motor is a Stirling motor, described in U.S. Pat. No. 4,511,805, which operates by having one part of the thermal motor hot and another part cold.

During operation, the thermal motor 116 may take hot fluid 128 and ice cold water 115 (derived from melted ice in storage 113), and will extract energy from the temperature difference between the hot fluid 128 and ice cold water 115 to turn a motor shaft which is mechanically connected to an electrical generator 125. Electrical generator 125 may then generate electric current output 126. After extracting energy from the hot fluid 128 and ice cold water 115, thermal motor 116 may output hot fluid 128 as warm fluid 117 and output ice cold water 115 as cool water 121 to fresh water storage 131 which may provide fresh water output 123.

In other embodiments, the speed of the shaft 124, and thus the amount of electric power generated, may be regulated by pumps 114 and 123 controlling the flow of ice cold water 115 and hot fluid 128, respectively, into thermal motor 116. If only a small amount of hot and cold fluids are pumped into the thermal motor 116, then the shaft speed will be slow. Consequently, the amount of electric output 126 produced by the electrical generator 125 will be correspondingly low. Similarly, if the shaft rotation speed increases due to pumping more hot fluid 128 and cold water 115 into the thermal motor 116 (up to a limit), the amount of electric output 126 of the electrical generator 125 increases. Although not shown in FIG. 1, it is also possible to have multiple thermal motors 116 and electrical generators 125 in other embodiments, and it may be easier to control the electrical output 126 where there are multiple thermal motors 116 and electrical generators 125.

In addition to storing ice, it may be advantageous to also store hot water or other hot fluid. As shown in FIG. 1A, a solar/electrical heater 119 heats warm fluid held in a warm fluid storage tank 118 to make hot fluid 129 where it is stored in a hot fluid storage tank 120. Alternatively, in one embodiment, the hot liquid may be heated by using an electric heater. The hot fluid may be fresh water, saline water, oil, or a molten salt. In other embodiments, the oil or molten salt may already be available as byproduct from some types of solar power generators and may already be heated. An advantage of using oil or molten salt is that the maximum temperature can be higher than that of fresh or saline water, and thus increase the temperature difference applied to the thermal motor. On the other hand, it may be more practical and less expensive to heat and store large amounts of fresh or saline water, especially when storing millions of liters of hot water.

In another embodiment, the hot fluid may come from a geothermal source preheated, such as the heat for a geyser or hot-spring. Likewise, another embodiment may use the refrigerator unit's heat to warm the hot liquid. The refrigerator unit's condenser emits a heat byproduct during the process of freezing the ice, which, instead of being vented, could be used to heat the hot liquid.

With reference to FIG. 1B, depicted is an embodiment which may functional similarly to the embodiment shown in FIG. 1A. As shown in FIG. 1B, the system combines some functions of FIG. 1A to reduce the cost of implementation. Because the system of FIG. 1A can include two modes of operation, there may be no need to run the compressor and generator at the same time. Accordingly, the system of FIG. 1B may include motor/generator 150 to perform the functions of compressor motor 103 and generator 125 of FIG. 1A. Motor/generator 150 may drive a compressor in the first mode of operation and generate electricity in the second mode of operation. Motor/generator 150 may include electrical energy input connection 155 coupled to a power source (e.g., power source 101) and electrical output connection 156. It should be appreciated that like elements of FIG. 1B correspond to elements of FIG. 1A.

There similarly may be no need to run the compressor and thermal motor at the same time. Thus, in the embodiment of FIG. 1B, compressor 104 and thermal motor 116 of the system of FIG. 1A may be combined to form the compressor/thermal motor 160. Compressor/thermal motor 120 can compress the refrigerant liquid in the first mode of operation. In the second mode of operation, the thermal motor drives the generator mechanically by extracting the energy difference between the cold water 115 and hot liquid 128. It should be appreciated in the art that other units in the system may also be combined.

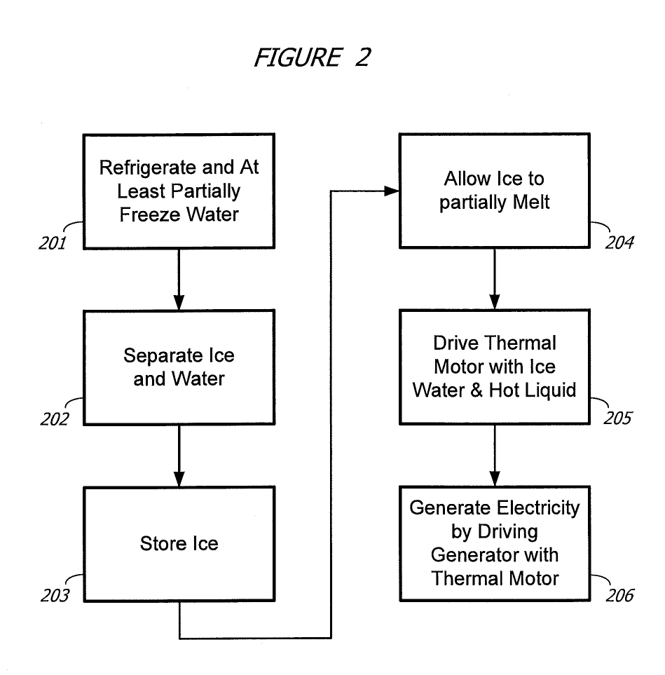

With reference to FIG. 2, a method is depicted for operation of an energy storage and release system according to one or more embodiments of the invention. The method in FIG. 2 may be initiated when there is excess energy to be stored in the system. The system begins to refrigerate and at least partially freeze water through the use of a refrigerating unit at block 201. The system separates the partially frozen water into ice and water at block 202. The ice is stored in an insulated ice storage unit at block 203. At least a portion of the ice may then be allowed to melt into ice and ice water components while in the storage unit at block 204. When energy release is desired, the ice water along with a hot liquid may be used to drive a thermal motor at block 205. The thermal motor in turn drives the electrical generator at block 206 to generate electricity. In addition, cool or desalinated water generated by the process of FIG. 2 can be released for other uses as described herein.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A system for storing and releasing electric energy comprising:
a refrigeration unit configured to at least partially freeze water into ice and further configured to separate the ice from an unfrozen water portion;
an insulated cold storage unit configured to receive and store said ice and any melted ice water portion of said ice;
a hot liquid source;
a thermal motor configured to operate when electricity is demanded, wherein the thermal motor is configured to be driven by each of said melted ice water portion and a hot liquid provided by the hot liquid source; and
an electrical generator driven by the thermal motor wherein the electrical generator is configured to produce electricity.

2. The system of claim 1, wherein the water to be at least partially frozen by the refrigeration unit is saline water.

3. The system of claim 2, wherein the unfrozen water portion has a higher salt concentration than a salt concentration of said ice.

4. The system of claim 3, wherein the refrigeration unit is further configured to receive water of the melted ice to be further desalinated, after water is provided to drive the thermal motor.

5. The system of claim 1, wherein the hot liquid source is a geothermal source of hot liquid.

6. The system of claim 1, wherein the hot liquid source relates to an insulated heat storage unit containing hot liquid.

7. The system of claim 6, wherein the hot liquid is heated by at least one of solar energy, electric energy, geothermal energy and thermal energy exhausted by the refrigerating unit.

8. The system of claim 6, wherein the hot liquid relates to at least one of oil and molten salt.

9. The system of claim 1, wherein the refrigeration unit is electrically actuated by at least one of a wind power source and solar power source.

10. The system of claim 1, further comprising a plurality of pumps controlling an amount of the hot liquid and an amount of the melted ice water portion driving the thermal motor.

11. The system of claim 10, wherein an amount of electric energy produced by the electrical generator is regulated by the amount of hot liquid and the amount of melted ice water portion pumped by said plurality of pumps into the thermal motor.

12. The system of claim 1, wherein the refrigeration unit is further configured as a holding unit to enable cold weather to at least partially freeze the water into the ice.

13. The system of claim 1, wherein the thermal motor is further configured to function as a compressor for the refrigeration unit when the thermal motor is not being used to drive the electrical generator.

14. The system of claim 1, wherein the electrical generator is further configured to be used as a motor to drive a compressor of the refrigeration unit when the electrical generator is not being used to create electric power.

15. The system of claim 1, further comprising a water output configured to output water for at least one of cooling an office building, cooling a residential building, cooling a data center, a potable water source and irrigation for crops.

16. A method for storing and releasing electric energy comprising the acts of:
refrigerating water to at least partially freeze the water into ice;
separating the ice from an unfrozen water portion;
storing the ice in an insulated storage unit;
allowing the ice to partially melt to form a melted ice water portion;
driving a thermal motor unit with the melted ice water portion and a hot liquid from a hot liquid source; and
generating electric energy from an electrical generator driven by the thermal motor unit.

17. The method of claim 16, wherein the water to be at least partially frozen is saline water.

18. The method of claim 17, wherein the unfrozen water portion has a higher salt concentration than a salt concentration of said ice.

19. The method of claim 18, wherein the method further comprises inputting the melted ice water portion to a refrigeration unit for freezing and further desalination after the melted ice water portion is used for driving the thermal motor.

20. The method of claim 16, wherein the hot liquid source relates to a geothermal source of hot liquid.

21. The method of claim 16, wherein the hot liquid source relates to at least one of solar energy, electric energy, geothermal energy, and thermal energy exhausted by a refrigeration unit.

22. The method of claim 16, wherein the hot liquid is relates to at least one of oil and molten salt.

23. The method of claim 16, wherein refrigerating comprises powering a refrigeration unit using at least one of electricity, a wind power source and a solar power source to at least partially freeze the water into ice.

24. The method of claim 16, further comprising the act of controlling, by a plurality of pumps, an amount of hot liquid and an amount of melted ice water portion inputted into the thermal motor.

25. The method of claim 24, wherein the amount of electric energy produced by the electrical generator is regulated by the amount of hot liquid and the amount of melted ice water portion pumped by said plurality of pumps into the thermal motor.

26. The method of claim 16, wherein refrigerating water comprises refrigerating water using cold weather to at least partially freeze the water into ice.
